(19) United States
(12) Patent Application Publication
(10) Pub. No.: US 2003/0187712 A1
(43) Pub. Date: Oct. 2, 2003

(54) Decision tree systems and methods

(75) Inventors: Mark G. Arthus, Nesconset, NY (US); Michael L. Sgaraglio, Massapequa Park, NY (US); William S. Miller, Bayshore, NY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO

(21) Appl. No.: 10/108,781

(22) Filed: Mar. 27, 2002

(51) Int. Cl. G06F 17/60

(52) U.S. Cl. 705/9

(57) ABSTRACT

A method of creating a decision tree includes receiving at a server computer information relating to a first node of the decision tree. The information is stored. Additional information is received at a server computer relating to at least one additional node of the decision tree. The additional information is stored such that the information and the additional information are interrelated with respect to a hierarchical structure. Methods for using the decision tree are also provided.

### CROSS-REFERENCES TO RELATED APPLICATIONS

This application is related to commonly assigned and concurrently filed U.S. patent application Ser. No. ______, entitled “SYSTEMS AND METHODS FOR MONITORING CREDIT RISK” (Attorney Docket No. 020375-008500US), by Michael L. Sgaraglio, and to commonly assigned and concurrently filed U.S. patent application Ser. No. ______, entitled “MERCHANT APPLICATION AND UNDERWRITING SYSTEMS AND METHODS” (Attorney Docket No. 020375-007100US), by Michael L. Sgaraglio, et al., and to commonly assigned and concurrently filed U.S. patent application Ser. No. ______, entitled “MERCHANT ACTIVATION TRACKING SYSTEMS AND METHODS” (Attorney Docket No. 020375-023900US), by Michael L. Sgaraglio, et al., and to commonly assigned and concurrently filed U.S. patent application Ser. No. ______, entitled “SYSTEMS AND METHODS FOR MANAGING COLLECTIONS RELATING TO MERCHANT ACCOUNTS” (Attorney Docket No. 020375-008300US), by Mark G. Arthus, et al., and to commonly assigned and concurrently filed U.S. patent application Ser. No. ______, entitled “SYSTEMS AND METHODS TO MONITOR CREDIT FRAUD” (Attorney Docket No. 020375-008400US), by Mark G. Arthus, et al., which applications are incorporated herein by reference in their entirety for all purposes.

### BACKGROUND OF THE INVENTION

This invention relates generally to the field of decision making processes. This invention relates more specifically to systems and methods for facilitating the creation and development of client information files.

Many businesses, especially businesses in the financial services sector, are extremely data intensive, meaning that such businesses rely on large volumes of information. Often the data is used in the process of making decisions with respect to the interests of the business or its clients. Further, the need to collect certain data or take particular actions results from conclusions reached only in light of previously collected information. Thus, rather than using less skilled labor to collect information, data-intensive businesses often rely on skilled analysts capable of making decisions during the data gathering process. Therefore, tools are needed that step less skilled workers through a data collection process following a path that an analyst would follow.

The process of collecting and organizing all the necessary data for a particular decision is generally time consuming. Computers are excellent tools for automating complex tasks; however, computers must be programmed appropriately. The process for creating a single computer program to automate one data collection process may not warrant the investment of time and money. Thus, data gathering tools are also needed that are applicable to a wide variety of applications.

Among other things, the present invention provides methods for using decision trees to guide workers through the process of developing client data files. Furthermore, the present invention also provides systems and methods for creating decision trees for such processes.

### BRIEF SUMMARY OF THE INVENTION

The invention provides various methods for creating and completing decision trees to facilitate business processes. The methods may conveniently be implemented over a computer network, such as the Internet, and may use hardware and software that are configured to operate in a network environment as is known in the art. For example, the invention may employ one or more server computers that access one or more data storage devices, such as databases, to store and process the information. Essentially any type of computer that may communicate over a network may be used to access and display information, as is known in the art.

In one exemplary embodiment, a method of creating a decision tree includes receiving at a server computer information relating to a first node of the decision tree and storing the information. The method further includes receiving additional information at a server computer relating to at least one additional node of the decision tree and storing the additional information such that the information and the additional information are interrelated with respect to a hierarchical structure. The method may further include sending from the server computer a representation of the hierarchical structure and receiving at the server computer a request to change the hierarchical structure. Additionally, the information and the additional information may include at least one data field to be completed at each node of the decision tree.

In another example, a method of creating a decision tree includes entering information relating to a first node of the decision tree and transmitting the information to a server computer. The method also includes entering additional information relating to at least a second node of the decision tree and transmitting the additional information to the server computer. The method also includes entering interrelationship information that defines an interrelationship among the nodes of the decision tree with respect to a hierarchical structure. The method may include sending instructions to the server computer to reorder the nodes of the decision tree with respect to the hierarchical structure. The method may also include sending instructions to the server computer to regroup the nodes of the decision tree with respect to the hierarchical structure. The information and the additional information may include at least one data field to be completed at each node of the decision tree.

In yet another example, a system for creating a decision tree includes a storage arrangement and a server computer related to the storage arrangement. The server computer is configured to receive information relating to a first node of the decision tree and cause the information to be stored at the storage arrangement. The server computer is further configured to receive additional information relating to at least one additional node of the decision tree and cause the additional information to be stored at the storage arrangement such that the information and the additional information are interrelated with respect to a hierarchical structure. The server computer also may be configured to transmit a representation of the hierarchical structure. The server computer also may be configured to alter the hierarchical structure in response to received instructions.

In another example, a method of using a decision tree to create an electronic file includes entering a response to a statement in a first node of the decision tree and transmitting the response to a server computer. The method also includes entering responses to at least a second node of the decision tree and transmitting the responses to a server computer. The method also includes initiating an action as directed by the decision tree based on the responses to the nodes of the decision tree.

In yet another example, a method of using a decision tree to create an electronic file includes receiving at a server computer a request to initiate a decision tree and transmitting the structure of the decision tree, including the content of a first node of the decision tree. The method also includes receiving at the server computer a response to a first node of the decision tree and transmitting the content of at least a second node of the decision tree. The method also includes receiving at the server computer a response to at least the second node of the decision tree and transmitting the content of at least a third node of the decision tree. The content of the third node is based in part on the responses to the first and at least the second nodes of the decision tree. The method also may include tracking the rate at which a user completes the nodes of at least one decision tree and receiving a request to display the rate at which the user completes nodes of the at least one decision tree. The method also may include accessing a database to obtain information to enter into a different node of the decision tree based at least in part on the response to at least one node of the decision tree. The method also may include transmitting the content of a fourth node of the decision tree based at least in part on the response to at least one node of a decision tree, wherein the fourth node is other than the next node in a sequence of nodes following the completed nodes. The method may also include providing a default response to a node of the decision tree based at least in part on the response to at least one node of a decision tree. The method may further include providing context-sensitive help information in response to a request from a user, the help information being based at least in part on information provided in response to at least one node of the decision tree.

In yet another example, a decision tree includes a plurality of nodes, each node having a node instruction and a node data entry field for responding to the instruction. The decision tree also includes at least one sub-node, each sub-node having a sub-node instruction and a sub-node data entry field for responding to the instruction. The at least one sub-node and the nodes are related with respect to a dynamic hierarchical structure. The nodes and the at least one sub-node are configured for presentation according to the dynamic hierarchical structure such that dynamic hierarchical structure changes in relation to responses to nodes or sub-nodes. The instructions may include and instruction to write a letter, an instruction to answer a question, an instruction to generate a report and/or an instruction to confirm receipt of payment. The nodes and the at least one sub-node may be further configured for presentation according to the dynamic hierarchical structure such that a next node or sub-node is presented only upon the occurrence of a response to an immediately previous node or sub-node in the dynamic hierarchical structure.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1 illustrates a schematic representation of a computer system that may be configured to implement methods of the present invention;

FIG. 2 illustrates a flow diagram of an embodiment of a method of creating a decision tree according to the present invention;

FIG. 3 illustrates a flow diagram of another embodiment of a method of creating a decision tree according to the present invention;

FIG. 4 illustrates a first decision tree construction display screen for constructing a decision tree according to the present invention;

FIG. 5a illustrates a first view of an add node display screen for use in constructing a decision tree according to the present invention;

FIG. 5b illustrates a second view of the add node display screen for use in constructing a decision tree according to the present invention;

FIG. 6a illustrates a first view of a second decision tree construction display screen for constructing a decision tree according to the present invention;

FIG. 6b illustrates a second view of the second decision tree construction display screen for constructing a decision tree according to the present invention.

FIG. 7a illustrates a first view of an update node display screen for constructing a decision tree according to the present invention.

FIG. 7b illustrates a second view of an update node display screen for constructing a decision tree according to the present invention.

FIG. 8 illustrates a flow diagram of an embodiment of a method of using a decision tree according to the present invention.

FIG. 9 illustrates a decision tree display screen according to the present invention.

### DETAILED DESCRIPTION OF THE INVENTION

The present invention provides systems and methods for creating and using decision trees to facilitate complex data gathering and decision making processes. Such processes can include most any human-controlled process reducible to a checklist or flowchart. By doing so, a business can shift the process from more skilled, thus typically more expensive workers, to less skilled clerks or administrative personnel.

In order to accomplish certain business functions, many businesses need to collect and analyze data relating to the function. For example, in the credit card transaction processing industry, a processing entity establishes accounts with merchants about whom the processing entity must maintain files and make decisions relating to credit worthiness and the like. The establishment and maintenance of such relationships is further explained in previously incorporated, copending, commonly assigned and concurrently filed U.S. patent application Ser. No. ______, entitled “MERCHANT APPLICATION AND UNDERWRITING SYSTEMS AND METHODS” (Attorney Docket No. 020375-007100US) and in previously incorporated, copending, commonly assigned and concurrently filed U.S. patent application Ser. No. ______, entitled “MERCHANT ACTIVATION TRACKING SYSTEMS AND METHODS” (Attorney Docket No. 020375-023900US). In such relationships, the processing entity may, for example, need to evaluate whether the merchant represents a greater credit risk that previously believed. Processes for evaluating credit risk are more fully explained in previously incorporated copending, commonly assigned and concurrently filed U.S. patent application Ser. No. ______, entitled “SYSTEMS AND METHODS FOR MONITORING CREDIT RISK” (Attorney Docket No. 020375-008500US). Or, processing entities may need to evaluate cases of suspected fraud. Processes for evaluating such circumstances are more fully explained in previously incorporated copending, commonly assigned and concurrently filed U.S. patent application Ser. No. ______, entitled “SYSTEMS AND METHODS TO MONITOR CREDIT FRAUD” (Attorney Docket No. 020375-008400US). Additionally, processing entities may need to evaluate the need to initiate collections against a merchant. Processes for evaluating collections decisions are more fully explained in previously incorporated copending, commonly assigned and concurrently filed U.S. patent application Ser. No. ______, entitled “SYSTEMS AND METHODS FOR MANAGING COLLECTIONS RELATING TO MERCHANT ACCOUNTS” (Attorney Docket No. 020375-008300US). Decision trees according to the present invention may be beneficial in these and many other circumstances.

A “decision tree” is an ordered approach to completing a business process. The process may involve collecting data, sending letters, generating reports, receiving payment and the like. As the process proceeds, future steps may change as a result of prior steps. Thus, a decision tree may be thought of as a flowchart combined with a checklist.

According to the present invention, completing a decision tree for a business process may be carried out with the assistance of a computing device. The computing device presents a sequence of steps or nodes that constitute the decision tree. The nodes may require the user to acquire some data, produce a report, send a letter, place a call, verify payment or the like. Nodes may also contain sub-nodes. Thus, the combination of nodes and sub-nodes forms a hierarchical structure. The computer may be configured to display the next node only after the user has completed the prior node. Thus, the computing device essentially forces the user to follow an ordered process.

As nodes of the decision tree are completed, the content of uncompleted nodes may change according to actions taken with respect to completed nodes. In this way, the decision tree can adapt to a myriad of possible situations a user might encounter—situations which, heretofore, required the skills of an analyst. Also, as nodes are completed, data may be entered automatically into uncompleted nodes, thus competing them and eliminating the need to spend additional effort. For example, if a first node requests an account number for a client, the system may access a database to obtain the client's address information, which may be the subject of a later node. Further, according to the present invention, by tracking the rate at which a worker completes nodes, supervisors may monitor the progress of workers whose responsibilities include using decision trees.

Many convenient user interfaces may be used to implement the present invention. For example, the interface may function similarly to a web-browser, wherein the nodes appear as hyperlinks in a browser window. Continuing with this non-limiting example, when a node is the “active” node, i.e., the node being completed, the content of the node may appear in a second browser window. The second browser window may include a question to which the user responds, for example, by entering information into a data field, making a selection from a dropdown menu, or the like. The second browser window may also include an instruction to complete a task, to which the user responds by indicating that the task has been completed. Conveniently, if the present invention is implemented using a browser interface, then the decision tree process may in fact be accomplished via the Internet or other communications network.

A number of additional features may be employed according to the present invention to assist a user with completing a decision tree. For example, each node may include context-sensitive help messages that either appear automatically or in response to certain actions taken by the user. The help messages may instruct the user as to where to find information to complete the node, the type of information to enter and the like. Further, the decision tree may include logic that evaluates an entry into a node and rejects entries that are out of range, out of context, of the wrong data type and the like.

In light of the disclosure herein, it is apparent to those skilled in the art how to use decision trees. However, the present invention also provides systems and methods for creating decision trees. Further, the systems and methods of the present invention may be accomplished by typical managers and supervisors who lack the skills of computer programmers.

According to the present invention, a user may create a decision tree using an interactive computer program. A computing device renders on a computer screen a template having icons for initiating steps in the process of creating a decision tree. As with the decision tree itself, the steps in the process of creating a decision tree may take place in a browser-like environment. For example, the process may begin with the user selecting an icon to add a node. In response, the computing device displays a screen having a number of data fields for entering information that defines the node, including its relationship to other nodes. The user may continue the process for a number of nodes in a decision tree, after which the user may reorder the nodes, as desired.

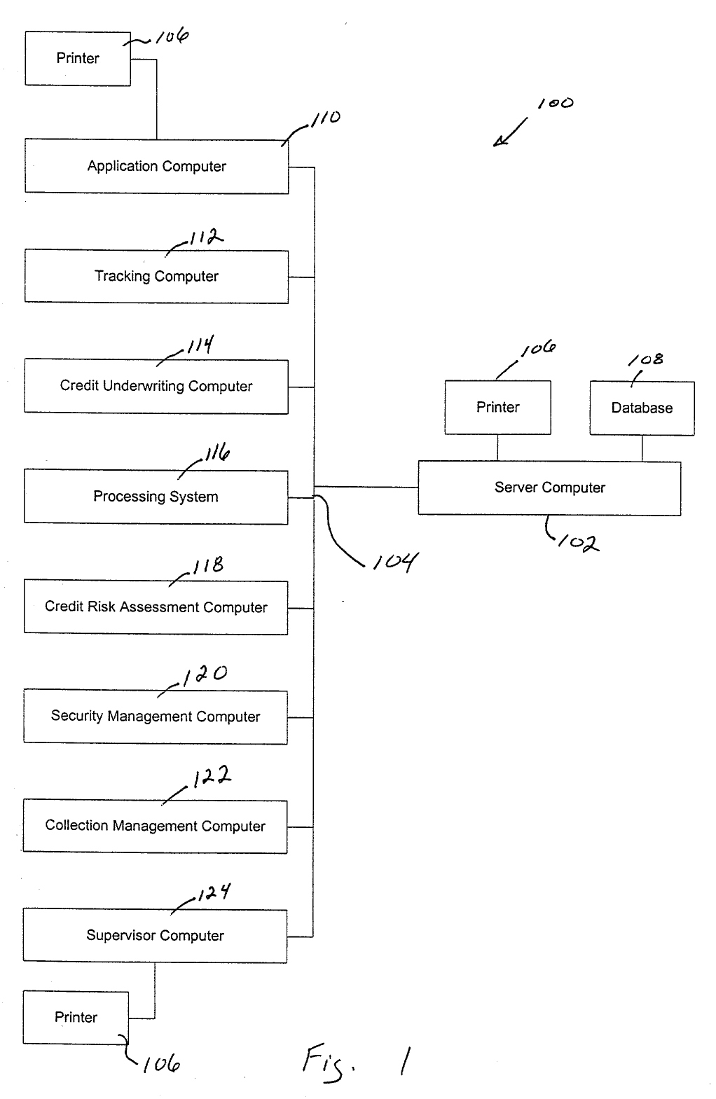

Referring to FIG. 1, a system 100 according to one embodiment of the present invention is illustrated. However, the present invention is not limited to this example of the present invention. Those skilled in the art will appreciate that the present invention may be embodied in a number of different configurations. The system 100 includes a server computer 102 connected to a network 104. Through the network 104, the server computer 102 may communicate with a number of different computers to be described hereinafter. The server computer 102 may be any of a wide variety of computing devices known to those skilled in the art. The network 104 may be, for example, the Internet, a wide area network, a local area network, or the like, or any combination of the foregoing.

The server computer 102 may contain a number of different applications that permit the server computer 102 to interact with other computers, computer users, peripherals, such as printers 106, and storage systems, such as a database 108. The database 108 may be integral to the server computer 102 or may be connected via any number of network configurations, as is known in the art.

Through the network 104, the server computer 102 may be, according to this non-limiting example, connected to one or more application computers 110, tracking computers 112, credit underwriting computers 114 and/or processing systems 116, all of which are more fully explained in previously incorporated U.S. patent application Ser. No. ______, entitled “MERCHANT APPLICATION AND UNDERWRITING SYSTEMS AND METHODS” and in U.S. patent application Ser. No. ______, entitled “MERCHANT ACTIVATION TRACKING SYSTEMS AND METHODS”. Additionally, the server computer 102 may be connected to one or more credit risk computers 118, security management computers 120, or collection management computers 122, each of which are more fully explained in the respective previously incorporated U.S. patent application Ser. No. ______, entitled “SYSTEMS AND METHODS FOR MONITORING CREDIT RISK”, U.S. patent application Ser. No. ______, entitled “SYSTEMS AND METHODS TO MONITOR CREDIT FRAUD”, and U.S. patent application Ser. No. ______, entitled “SYSTEMS AND METHODS FOR MANAGING COLLECTIONS RELATING TO MERCHANT ACCOUNTS”. The server computer 102 may also be connected via the network 104 to one or more supervisor computers 124. The foregoing computers 110-124 may be any of a variety of computing devices known to those skilled in the art, including personal computers, work stations, personal digital assistants and the like.

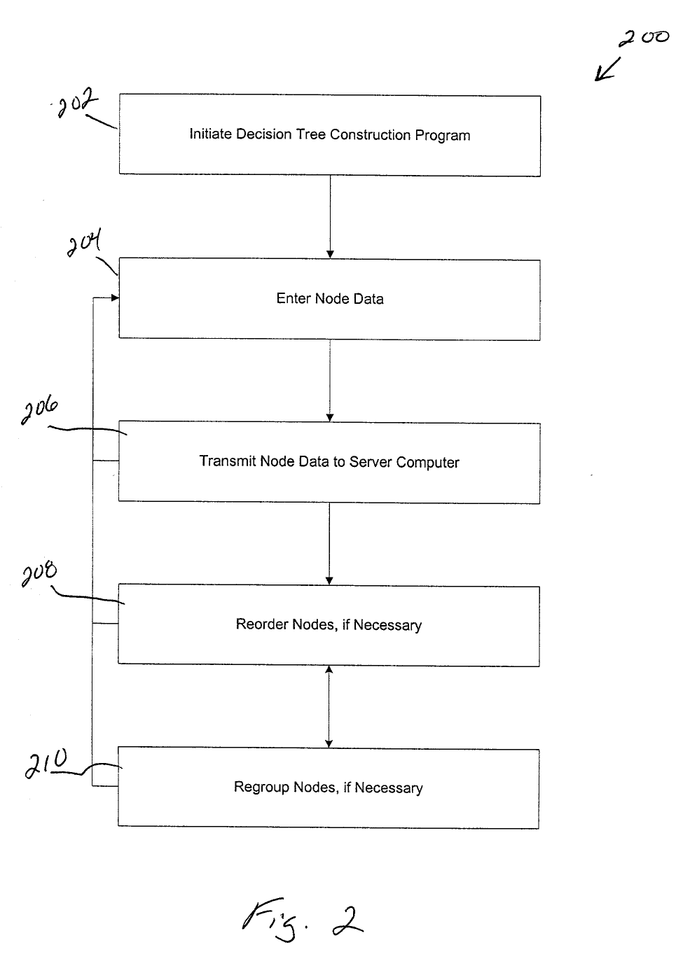

Referring to FIG. 2, one example of a method of building a decision tree 200 according to the present invention is illustrated. It will be appreciated that other examples are possible. Therefore, this example is not to be considered limiting. This exemplary method may be initiated, for example, at a computer, such as supervisor computer 124 of FIG. 1, by a person with knowledge of the subject matter of the decision tree. The method begins at operation 202, initiating the decision tree construction program. According to this example, the program is included among the applications on the server computer 102. The program operates within a web-browser environment, as will be explained more fully hereinafter. At operation 204, data relating to a first node is entered, and the data is transmitted to the server computer at operation 206. Operations 204 and 206 may be repeated for additional nodes and/or subnodes in the decision tree. At operation 208, the nodes may be reordered, if necessary. The nodes may also be regrouped at operation 210. Herein, reordering will refer to rearranging nodes within a node level, and regrouping will refer to moving a node between levels. At any stage in the process of creating a decision tree, additional nodes may be added and transmitted to the server computer, as indicated.

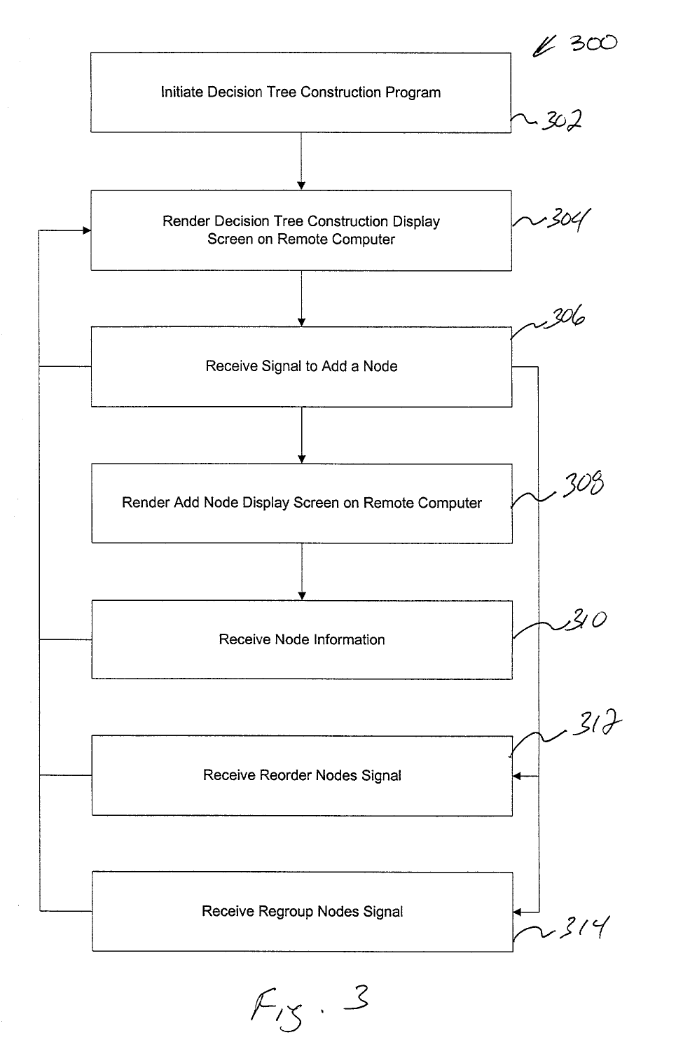

FIG. 3 illustrates a second example of a method of constructing a decision tree 300 according to the present invention, which may be practiced, for example, at a computer such as the server computer 102. At operation 302, the decision tree construction program is initiated. The server computer renders a decision tree construction screen on the remote computer at operation 304. At operation 306, the server computer receives an add node signal, in response to which the server computer renders an add node data screen on the remote computer at operation 308. At operation 310, the server computer receives node information. The server computer once again renders a decision tree construction screen at operation 304. Additional nodes may be added by repeating operations 306 and 308. The method 300 may also include receiving a signal to reorder the nodes at operation 312 and/or receiving a signal to regroup the nodes at operation 314.

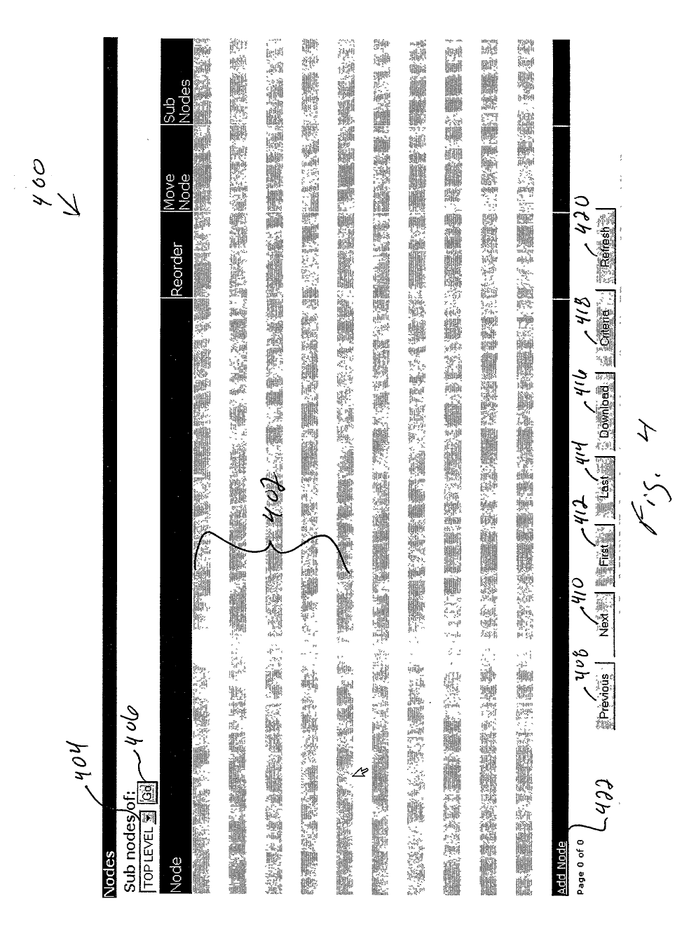

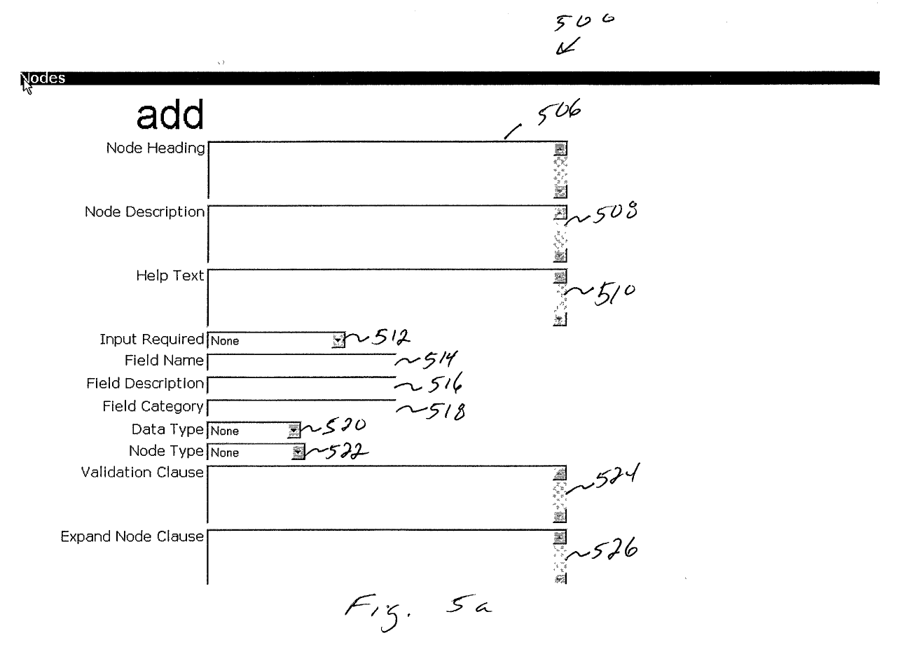

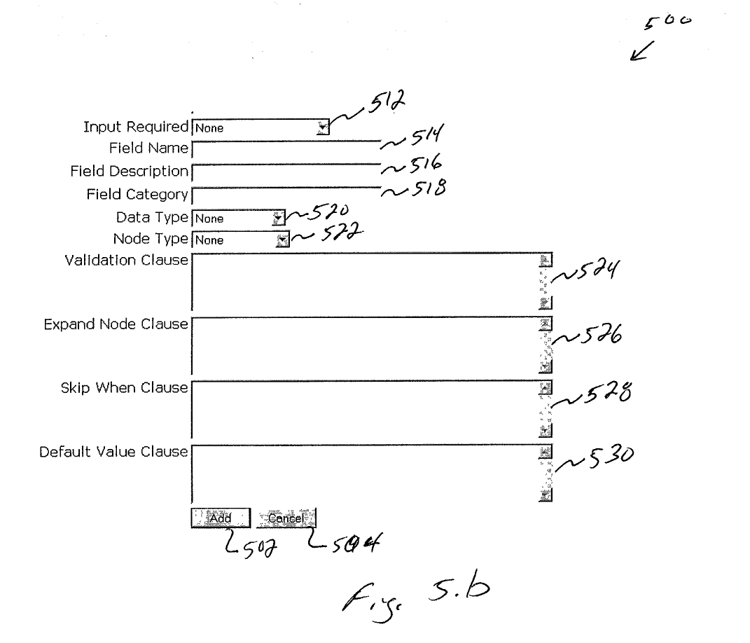

Referring to FIG. 4, a non-limiting example of a decision tree construction display screen 400 for constructing a decision tree is illustrated. The display screen 400 may appear inside a web-browser environment, for example, as previously discussed. The display screens 400 includes a number of icons and hyperlinks for navigating through the decision tree construction process. The display screen 400 presents one level of nodes at a time and includes an area 402 in which the nodes are listed. The display screen 400 includes a node level dropdown menu 404 and “Go” icon 406 for navigating through node levels. The following icons are also provided for navigating within a node level: previous 408, next 410, first 412, last 414, download 416, criteria 418 and refresh 420. The previous 408, next 410, first 412 and last 414 icons are for navigating among multiple pages in one node level, because it may be the case that only a certain number of nodes may be displayed on one display screen. The download icon 416 send the information of the current level to a spreadsheet file. The criteria icon 418 allows the user to instruct the server to display only nodes meeting certain conditions. The refresh icon 420 functions similarly to the well known refresh button found in web-browsers. An add node hyperlink 422 causes the add node display screen to be displayed which will be explained further with respect to FIGS. 5a and 5b.

Referring to FIGS. 5a and b, it will be appreciated that the figures are respectively the upper and lower portions of an add node display screen 500. The display screen 500 includes a number of data entry fields, dropdown menus and icons, such as the “add” icon 502, which transmits the data entered into the display screen to the server computer, and a “cancel” icon 504, which aborts the add node operation and causes the decision tree construction data screen 400 to be displayed.

The add node display screen 500 includes a node heading data field 506 for entering a heading to appear at the top of a node screen during completion of the decision tree, as will be described in more detail hereinafter. A node description data field 508 provides for the entry of a statement or question relating to the node. A help text data field 510 provides for the entry of help text that may be accessed by a user during completion of the decision tree. An input required dropdown menu 512 allows the creator of the decision tree to specify whether information must be entered into the node. For example, the creator of the decision tree may specify that data must be entered before continuing to the next node or before completing the decision tree. A field name data field 514 specifies the name of the data storage location to which the node entry will be written. A field description data field 516 provides for naming the node in a summary portion of the decision tree structure. A field category data field 518 provides for creating external reporting. Through the use of a data type dropdown menu 520, the creator of the decision tree can specify the data definition for the entry. Data types may include text, number, logical, date and the like. Through the use of a node type dropdown menu 522, the same detail may be specified for the node. For example, if the node requires an input, the node type may be defined as multiple choice, yes/no, and the like.

The validation clause data field 524, the expand node clause data field 526, the skip when clause data field 528, and the default value clause data field 530 allow the nodes to be interrelated. Each field may include logic that causes the node to function differently, depending on data entered in prior nodes of the decision tree. For example, the validation clause data field 524 allows the creator to specify information that may appear as help text in response to an invalid entry or a user request for assistance. Through the use of logic, valid entries may depend on information entered in prior nodes. The expand node clause data field 526 provides for controlling access to a sub-node. The skip when clause data field 528 eliminates the need to complete the node if certain conditions are true. The default value clause data field 530 allows for the specification of a default value that appears when the node is first presented, and the value may change, depending on entries into other nodes.

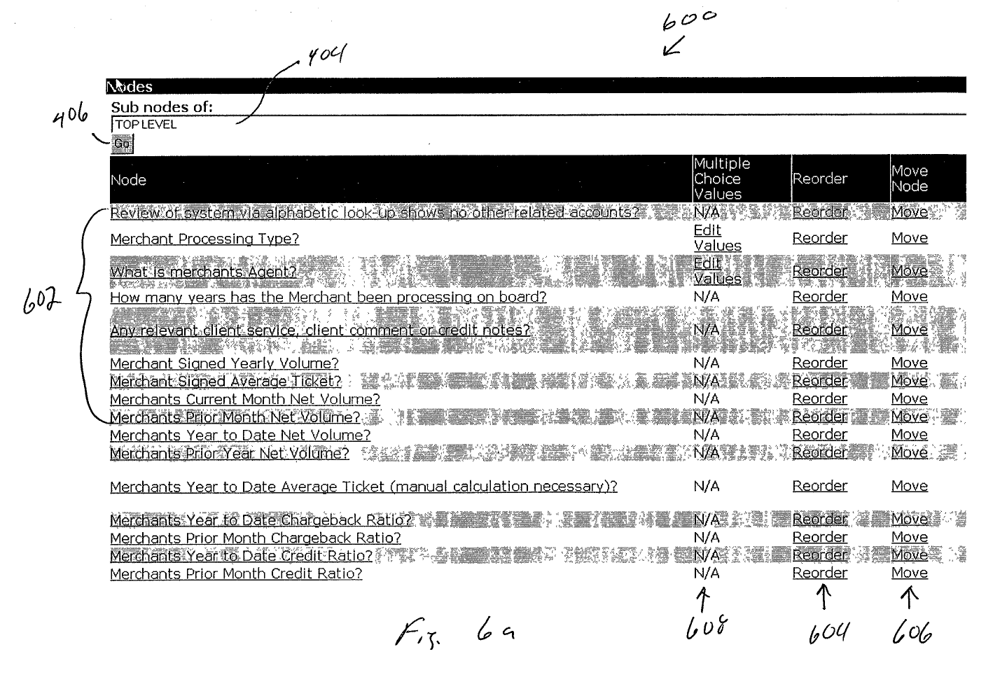

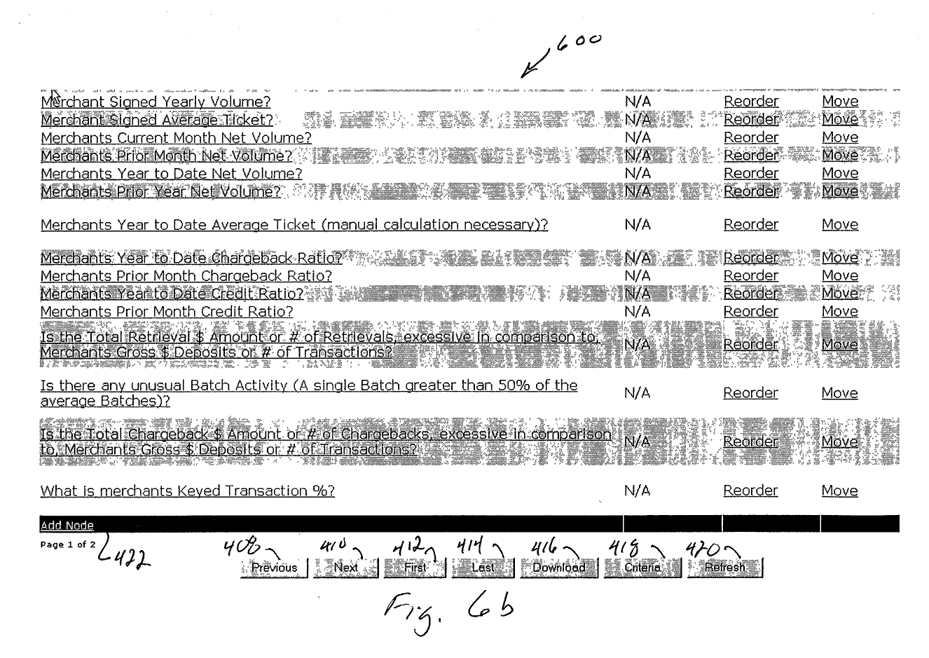

After entering information for the relevant data fields in the add node display screen 500, the creator may select the add icon 502 to transmit the information to the server and view the list of nodes in the current level, as shown in FIGS. 6a and b. FIGS. 6a and b are top and bottom views, respectively of a decision tree construction display screen 600 similar to the one presented in FIG. 4. However, display screen 600 lists a number of nodes that are included in the current level of a decision tree.

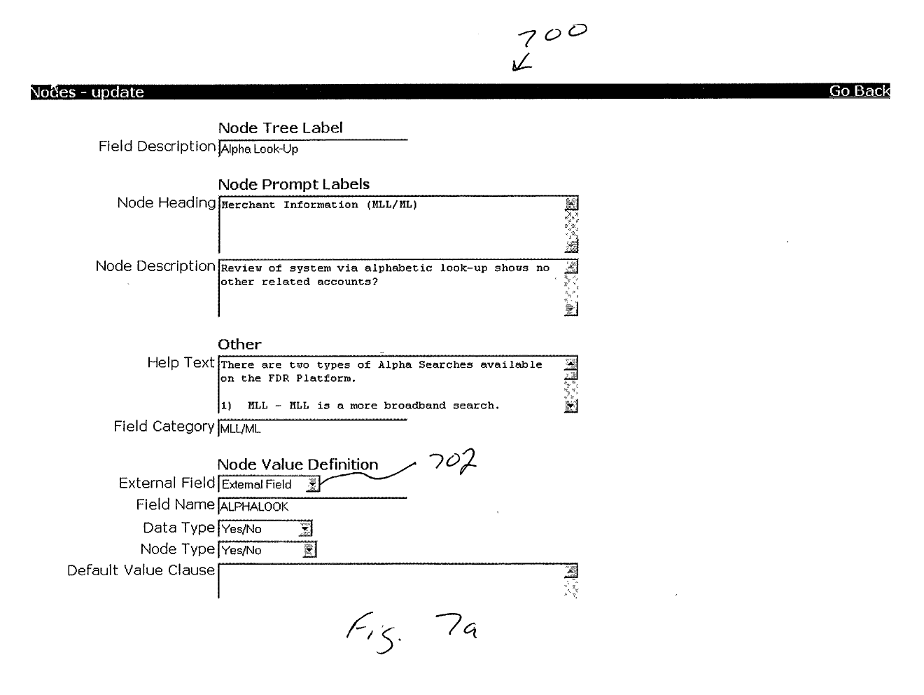

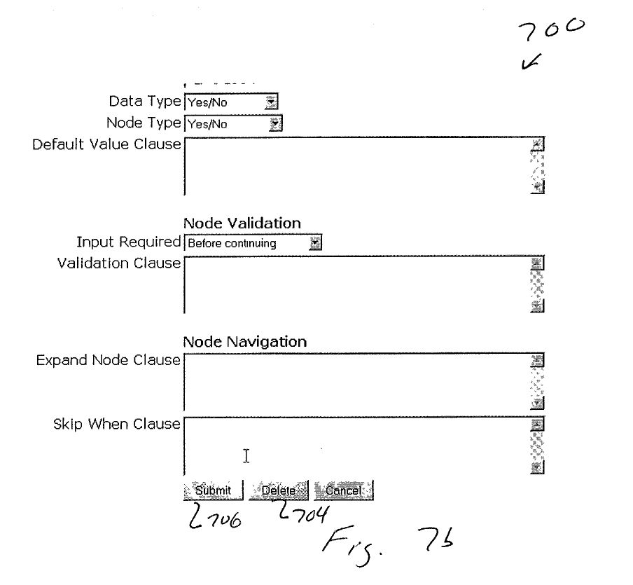

The decision tree construction display screen 600 includes navigation buttons 408-420, a node level dropdown menu 404 and “Go” icon 406, and an add node hyperlink 422, as previously discussed. Additionally, the display screen includes a list of nodes 602 that each function as hyperlinks to an update node display screen, illustrated in FIGS. 7a and b.

FIGS. 7a and b are top and bottom views respectively of the update node display screen 700. The display screen 700 includes many of the same fields as the add node display screen 500. However, the update node display screen also includes an external field dropdown menu 702 that relates to data fields in external files that may be updated as the decision tree is completed. Additionally, the update node display screen 700 includes a delete icon 704 for deleting the node. A submit icon 706 transmits the information to the server computer and renders a decision tree construction display screen similar to that described with respect to FIGS. 6a and b.

Referring back to FIGS. 6a and b, the decision tree construction screen 600 includes reorder hyperlinks 604 and move node hyperlinks 606 for each node. The reorder hyperlink 604 allows a node to be repositioned within a node level, while the move node hyperlink 606 allows a node to be relocated to a different level. The display screen 600 also includes a multiple choice values hyperlink 608 for certain of the nodes, which contain the values for multiple choice responses.

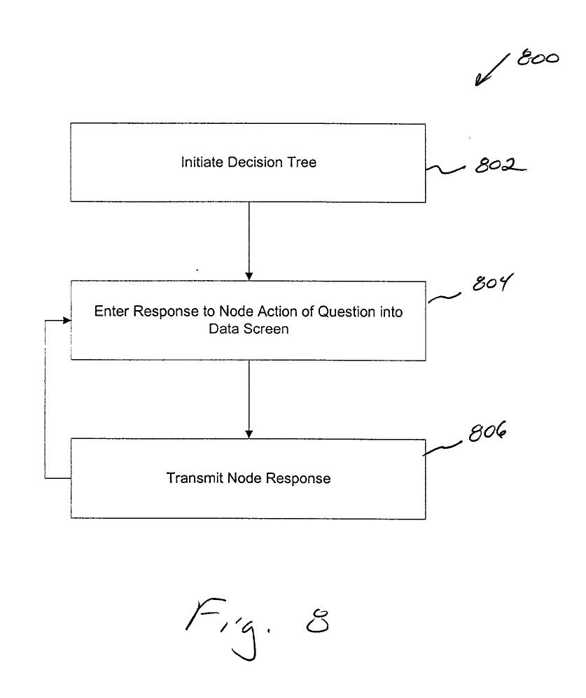

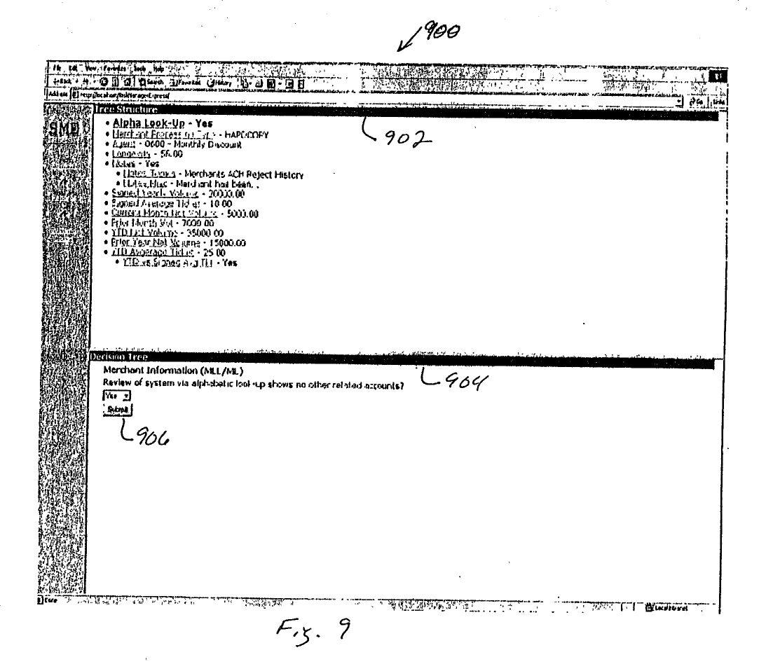

Having described systems and methods for creating decision trees, a system and method for completing a decision tree will be described with reference to FIGS. 8 and 9. Recalling the purpose of a decision tree in many applications, the decision tree is used to gather and analyze information relating to business operations. For example, a financial services business may desire to assist a client with a service related to the client's financial affairs. An administrative employee may use a decision tree to gather the appropriate information and make a recommendation to the client based on the information. A first node in the decision tree may instruct the employee to enter the client's account number, in response to which, the decision tree accesses the client's file and imports other client data. This eliminates the need for the employee to enter some of the additional information. Other nodes may instruct the employees to gather net worth and income information, for example. Based on the data entered by the employee, the final node of the decision tree may instruct the employee to make a particular recommendation to the client, the recommendation being based on the information entered in response to prior nodes. Thus, the employee is assisted to perform the function of a more skilled analyst through the use of a decision tree.

FIG. 8 illustrates the steps in one non-limiting example of a method 800 of creating a decision tree according to the present invention. A user initiates a decision tree at operation 802. As stated previously, the decision tree may be initiated at a remote computer that accesses a server computer via the Internet or other network. At operation 804, the user enters a response to a node of the decision tree then transmits the response at operation 806. Operations 804 and 806 may be repeated for additional nodes in the decision tree.

Referring to FIG. 9, a decision tree display screen 900 for a non-limiting example of a decision tree is illustrated. The decision tree screen 900 is illustrated in a web browser window, although this is not required. The display screen includes a tree structure window 902 and a node window 904. A portion of the list of nodes in a decision tree appears in the tree structure window, with subnodes slightly indented with respect to other nodes. Conveniently, colors may be used to represent completed nodes, uncompleted nodes, and uncompleted nodes that are required to be completed. Next to each node, a summary of the response to each node may appear.

In the node window 904, the content of each node appears as the node becomes the active node. In embodiments of the present invention, the next node appears automatically as each node is completed and only after the previous node is completed. The content of each node may include dropdown menus, data entry fields and the like. In most nodes, a submit icon 906 allows the user to initiate the operation of transmitting the node data to the server computer or other data storage area.

It is now apparent the relationship between the information entered in the add node display screen 500 and the decision tree screen 900. For example, the data entered into the field description data field 516 appears in the list of nodes of the tree structure window 902. The information entered into the node heading data field 506 appears at the top of the node window 904, along with the node description 508.

The present invention also provides additional aspects for creating and using decision trees. For example, through the use of the appropriate data fields discussed with respect to the add node display screen 500, the decision tree can be configured to import data from and export data to existing client files. The data may be stored for future purposes with respect to the client. Additionally, the system within which the decision tree operates may be configured to track the rate at which employees complete nodes in decision trees, thus allowing supervisors to develop metrics for evaluating employee productivity.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. For example, those skilled in the art know how to arrange computers into a network and enable communication among the computers through the use of web-browser software. Accordingly, the above description should not be taken as limiting the scope of the invention, which is defined in the following claims.

What is claimed is:

1. A method of creating a decision tree, comprising:
receiving at a server computer information relating to a first node of the decision tree;
storing the information;
receiving additional information at a server computer relating to at least one additional node of the decision tree;
storing the additional information such that the information and the additional information are interrelated with respect to a hierarchical structure.

2. The method as recited in claim 1, further comprising sending from the server computer a representation of the hierarchical structure.

3. The method as recited in claim 1, further comprising receiving at the server computer a request to change the hierarchical structure.

4. The method as recited in claim 1, wherein the information and the additional information include at least one data field to be completed at each node of the decision tree.

5. A method of creating a decision tree, comprising:
at a client computer, receiving information relating to a node of a decision tree;
sending from the client computer to a server computer the information relating to the node of the decision tree;
at the client computer, receiving from the server computer, a representation of the decision tree;
repeating the steps of receiving information, sending the information, and receiving the structure of the decision tree for additional nodes of the decision tree.

6. A method for creating a decision tree, comprising:
entering information relating to a first node of the decision tree into a computing device;
transmitting the information to a server computer;
entering additional information relating to at least a second node of the decision tree; and
transmitting the additional information to the server computer;
entering interrelationship information that defines an interrelationship among the nodes of the decision tree with respect to a hierarchical structure.

7. The method as recited in claim 6, further comprising sending instructions to the server computer to reorder the nodes of the decision tree with respect to the hierarchical structure.

8. The method as recited in claim 6, wherein the decision tree contains more than two nodes, the method further comprising sending instructions to the server computer to regroup the nodes of the decision tree with respect to the hierarchical structure.

9. The method as recited in claim 6, wherein the information and the additional information includes at least one data field to be completed at each node of the decision tree.

10. A system for creating a decision tree, comprising:
a storage arrangement; and
a server computer related to the storage arrangement;
wherein the server computer is configured to:
receive information relating to a first node of the decision tree;
cause the information to be stored at the storage arrangement;
receive additional information relating to at least one additional node of the decision tree;
cause the additional information to be stored at the storage arrangement such that the information and the additional information are interrelated with respect to a hierarchical structure.

11. The system of claim 10, wherein the server computer is further configured to transmit a representation of the hierarchical structure.

12. The system of claim 10, wherein the server computer is further configured to alter the hierarchical structure in response to received instructions.

13. A method of using a decision tree to create an electronic file, comprising:
entering a response to a statement in a first node of the decision tree;
transmitting the response to a server computer;
entering responses to a statement in at least a second node of the decision tree;
transmitting the responses to a server computer; and
initiating an action as directed by a third node of the decision tree, wherein the content of the third node is determined based on the responses to other nodes of the decision tree.

14. The method as in claim 13, wherein the statement comprises an item from the list consisting of instruction, request, and question.

15. A method of using a decision tree to create an electronic file, comprising:
at a client computer, receiving a structure of the decision tree
at the client computer, receiving a first node of the decision tree from a server computer;
displaying the first node;
receiving a response to a statement in the first node;
transmitting the response to a server computer;
repeating, at the client computer, for additional nodes of the decision tree, receiving the node, displaying the node, receiving a response and transmitting the response.

16. A method of using a decision tree to create an electronic file, comprising:
receiving at a server computer a request to initiate a decision tree;
transmitting the structure of the decision tree, including the content of a first node of the decision tree;
receiving at the server computer a response to a first node of the decision tree;
transmitting the content of at least a second node of the decision tree;
receiving at the server computer a response to at least the second node of the decision tree; and
transmitting the content of at least a third node of the decision tree, wherein the content of the third node is based in part on the responses to the first and at least the second nodes of the decision tree.

17. The method of claim 16, further comprising:
tracking the rate at which a user completes the nodes of at least one decision tree; and
receiving a request to display the rate at which the user completes nodes of the at least one decision tree.

18. The method of claim 16, further comprising:
based at least in part on the response to at least one node of the decision tree, accessing a database to obtain information to enter into a different node of the decision tree.

19. The method of claim 16, further comprising:
based at least in part on the response to at least one node of a decision tree, transmitting the content of a fourth node of the decision tree, wherein the fourth node is other than the next node in a sequence of nodes following the completed nodes.

20. The method of claim 16, further comprising:
based at least in part on the response to at least one node of a decision tree, providing a default response to a node of the decision tree.

21. The method of claim 16, further comprising:
in response to a request from a user, providing context-sensitive help information based at least in part on information provided in response to at least one node of the decision tree.

22. A computer-readable medium having an electronic representation of a decision tree, the decision tree, comprising:
a plurality of nodes, each node having a node instruction and a node data entry field for responding to the instruction; and
at least one sub-node, each sub-node having a sub-node instruction and a sub-node data entry field for responding to the instruction;
wherein the at least one sub-node and the nodes are related with respect to a dynamic hierarchical structure, wherein the nodes and the at least one sub-node are configured for presentation according to the dynamic hierarchical structure such that dynamic hierarchical structure changes in relation to responses to nodes or sub-nodes.

23. The computer-readable medium of claim 22, wherein the nodes and the at least one sub-node are further configured for presentation according to the dynamic hierarchical structure such that a next node or sub-node is presented only upon the occurrence of a response to an immediately previous node or sub-node in the dynamic hierarchical structure.

24. The computer-readable medium of claim 22, wherein the node and sub-node instructions are selected from the group consisting of:
instruction to write a letter;
instruction to answer a question;
instruction to generate a report; and
instruction to confirm receipt of payment.
